(19) United States
(12) Patent Application Publication
(10) Pub. No.: US 2017/0097930 A1
(43) Pub. Date: Apr. 6, 2017

(54) VOICE LANGUAGE COMMUNICATION DEVICE AND SYSTEM

(71) Applicant: Ruby Thomas, Houston, TX (US)

(72) Inventor: Ruby Thomas, Houston, TX (US)

(21) Appl. No.: 15/207,734

(22) Filed: Jul. 12, 2016

Related U.S. Application Data
(60) Provisional application No. 62/237,787, filed on Oct. 6, 2015.

(51) Int. Cl. G06F 17/28; G06F 3/16; G10L 15/00

(52) U.S. Cl. CPC G06F 17/2836; G10L 15/005; G06F 3/167

(57) ABSTRACT

A voice language communication device and system that includes: a speaker; a microphone; a display panel; a control panel; a power button; a record button; software stored on a hard drive; a language database, where software accesses the language database during operation; a plurality of languages stored on the language database; speech recognition functions related to the software, where the speech recognition functions recognizes a user's language as an input language; and an output language, where the output language is a translation of the input language and the output language is instantaneously emitted to the speaker.

### CROSS REFERENCE TO OTHER APPLICATIONS

This application claims priority to U.S. Provisional Application Ser. No. 62/237,787 filed on Oct. 6, 2015.

### BACKGROUND OF THE INVENTION

Field of Invention

The present invention relates to a small hand held device that provides a means for instantaneous language communication.

Description of Related Art

Communication across language barriers is imperative due to global communications, travel and information exchanges. Principally due to technology and increased travel individuals encounter foreign languages more often. In particular, when traveling in a foreign country it would be advantageous to have a system or means to communicate in the native language to facilitate the travel activities. Many times people must go through various learning programs in order to learn a particular language, which can be quite tedious and time consuming. Further some individuals are not as adept as others in learning a different language. As a result, it would be advantageous to have a hand held device that could easily provide a language communication function for a user.

### SUMMARY OF THE INVENTION

The present invention relates to a voice language communication device and system that includes: a speaker; a microphone; a display panel; a control panel; a power button; a record button; software stored on a hard drive; a language database, where software accesses the language database during operation; a plurality of languages stored on the language database; speech recognition functions related to the software, where the speech recognition functions recognizes a user's language as an input language; and an output language, where the output language is a translation of the input language and the output language is instantaneously emitted to the speaker.

### BRIEF DESCRIPTION OF DRAWINGS

FIG. 1 depicts a hand held language communication device in accordance with the present invention.

### DETAILED DESCRIPTION

The present invention relates to a hand held electronic device that performs instantaneous language conversion through the use of software installed on a hard drive within the device. The device includes a microphone, which receives audio from the user and the software includes functionality to interpret the language into a desired language for the user. Initially, the user elects an input language and an output language for the device. By using a language database within the device, the device provides an instantaneous translation of this input language to the output language for use by the user. The output language can be output through synthesized voice so that a second party may hear it. Further the same text may be translated into written text for email or texting purposes. The communication device also provides a plurality of the control buttons such as volume, menu, record, power and saving capabilities.

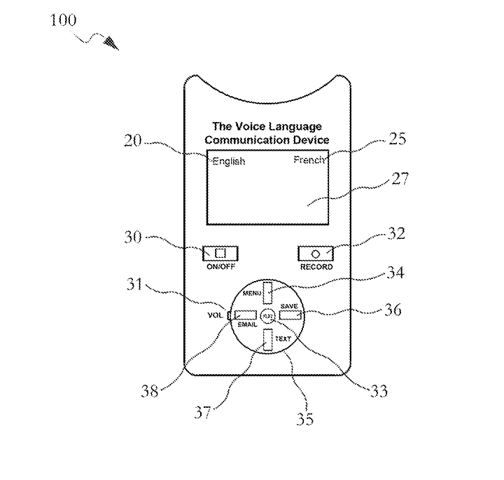

With respect to FIG. 1, a language communicator 100 is depicted. The language communicator 100 includes a screen (27). On the screen (27) the text of the audio recording may be visible. Further an input language (20) provided and an output language (25) is provided so that the user is aware of the output language (25). The power button (30) is provided along with a record button (32). A user uses a menu to navigate through functions associated with the language communicator 100. The menu may be activated through a menu button (34) where the user selects an input language (20) and output language (25). Once the record button (32) is hit the user speaks into the device, the device receives the audio and instantaneously translates it to an output language (25). This output language (25) may be emitted through a synthesized voice through a speaker on the translation device 100. The output language (25) is instantaneously transmitted to the speaker as the user provides the input language (20). Alternatively text may be provided on the screen that could be transferred via email or a text message on a cellular phone. Control panel (35) shows the various functional control buttons associated with the language translation device 100. A volume button (31), a text button (37) and a play button (33) are provided. A save button (36) and email button (38) are also shown. As mentioned above, the user controls functions through the menu button (34) that is also shown on the control panel (35). As indicated this language communicator receives an input and emits audio of an output language for the user. As a result the user can converse with another person who is speaking a different language. The user may simply toggle the input and output languages and allow the other person to speak into the device to receive a response. The device may be powered through the use of rechargeable batteries and preferably is a hand held device that is about the size of a typical smart phone. The instant invention has been shown and described in what it considers to be the most practical and preferred embodiments. It is recognized, however, that departures may be made there from within the scope of the invention and that obvious modifications will occur to a person skilled in the art.

What is claimed is:

1. A voice language communication device and system comprising:
a. a speaker;
b. a microphone, where the microphone receives input from a first user;
c. a display panel;
d. a control panel;
e. a power button;
f. a record button;
g. operating instructions in the form of software residing on memory for the device;
h. a language database, where the language database is stored in the memory and is accessible during operation;
i. a plurality of languages stored within the language database;
j. speech recognition functions related to the software, where the speech recognition functions recognizes a user's language as an input language; and
k. an output language, where the output language is a translation of the input language and the output language is instantaneously emitted to the speaker.

2. The voice language communication device according to claim 1, where the input is visible on the display panel.

3. The voice language communication device according to claim 1, where an input language and an output language is shown on the display panel.

4. The voice language communication device according to claim 1, further including a menu button where the menu button is adapted to navigate through the functions of the language communicator.
